(19) United States
(12) Patent Application Publication
(10) Pub. No.: US 2014/0216632 A1
(43) Pub. Date: Aug. 7, 2014

(54) METHOD FOR PRODUCING ACTIVE MATERIAL MOLDED BODY, ACTIVE MATERIAL MOLDED BODY, METHOD FOR PRODUCING LITHIUM BATTERY, AND LITHIUM BATTERY

(71) Applicant: SEIKO EPSON CORPORATION, Tokyo (JP)

(72) Inventors: Sukenori ICHIKAWA, Suwa-shi (JP); Tomofumi YOKOYAMA, Kai-shi (JP)

(73) Assignee: SEIKO EPSON CORPORATION, Tokyo (JP)

(21) Appl. No.: 14/172,431

(22) Filed: Feb. 4, 2014

(30) Foreign Application Priority Data
Feb. 5, 2013 (JP) 2013-020422

(51) Int. Cl. H01M 4/04; H01M 4/525; C01D 15/02; H01M 4/1391

(52) U.S. Cl. CPC H01M 4/0433; H01M 4/1391; H01M 4/525; H01M 4/0471; H01M 4/0407; H01M 4/0416; C01D 15/02
USPC 156/89.12; 264/618; 423/594.6; 252/182.1

(57) ABSTRACT

A method for producing an active material molded body includes molding a constituent material containing LiCoO₂ in the form of a powder by compression, and then performing a heat treatment at a temperature of 900° C. or higher and lower than the melting point of LiCoO₂.

### BACKGROUND

1. Technical Field

The present invention relates to a method for producing an active material molded body, an active material molded body, a method for producing a lithium battery, and a lithium battery.

2. Related Art

As a power source for many electronic devices such as portable information devices, a lithium battery (including a primary battery and a secondary battery) has been used. The lithium battery includes a positive electrode, a negative electrode, and an electrolyte layer which is disposed between the layers of these electrodes and mediates conduction of lithium ions.

Recently, as a lithium battery having a high energy density and safety, an all-solid-state lithium battery using a solid electrolyte as a constituent material of an electrolyte layer has been proposed (see, for example, JP-A-2006-277997 (PTL 1) and JP-A-8-180904 (PTL 2)).

In the lithium battery disclosed in PTL 1 or PTL 2, a molded body composed of an active material (hereinafter referred to as “active material molded body”) is used in an electrode. In order to form a high-power lithium battery, it is required for the active material molded body to have favorable conductive properties. In the lithium battery disclosed in PTL 1 or PTL 2, by adding a conducting aid such as acetylene black or ketchen black (registered trademark) to the active material molded body, necessary conductive properties are secured.

However, such a conducting aid is not involved in a battery reaction itself of the active material, and therefore, by adding the conducting aid, the performance of the active material molded body may be deteriorated. Further, when performing a heat treatment at a high temperature in the process for forming the active material molded body, the conducting aid may be damaged by burning, and therefore, it may be sometimes difficult to exhibit desired conductive properties even if the conducting aid is added.

### SUMMARY

An advantage of some aspects of the invention is to provide a method for producing an active material molded body, which is preferably used in a lithium battery and can form a high-power and high-capacity lithium battery. Another advantage of some aspects of the invention is to provide an active material molded body, which is preferably used in a lithium battery and can form a high-power and high-capacity lithium battery. Still another advantage of some aspects of the invention is to provide a method for producing a lithium battery, which includes such an active material molded body and therefore has high output power and high capacity, and also to provide a lithium battery.

An aspect of the invention provides a method for producing an active material molded body including molding a constituent material containing LiCoO₂ in the form of a powder by compression, and then performing a heat treatment at a temperature of 900° C. or higher and lower than the melting point of LiCoO₂.

By setting the heat treatment temperature to 900° C. or higher, the activation energy of the active material molded body can be decreased to 2×10⁻¹ eV or less, and the electronic properties of the active material molded body become metallic. When using the active material molded body obtained by this method, the electrical resistance of an electrode in a lithium battery is decreased so that the internal resistance of the lithium battery is decreased, and thus, the output power of the battery is improved.

Further, by limiting the heat treatment temperature to a value lower than the melting point of LiCoO₂, the melting or decomposition of LiCoO₂ can be prevented, and therefore an active material molded body having desired shape and physical properties can be obtained.

Therefore, according to this method, an active material molded body which is favorably used in a lithium battery and can form a high-power and high-capacity lithium battery can be preferably produced.

In one aspect of the invention, the production method may be configured such that the heat treatment is performed in an oxygen-containing atmosphere having an oxygen partial pressure of 0.1 Pa or more and 101 kPa or less.

According to this method, the reduction of LiCoO₂ during the heat treatment can be prevented, and therefore an active material molded body having desired physical properties is easily produced.

In one aspect of the invention, the production method may be configured such that the heat treatment is performed in an air atmosphere.

According to this method, special control of the concentration of oxygen is not needed, and therefore, the step becomes simple.

In one aspect of the invention, the production method may be configured such that the heat treatment is performed at a temperature of 900° C. or higher and 920° C. or lower.

If the heat treatment is performed at a temperature higher than 920° C., a side reaction generating Co₂O₄ from LiCoO₂ on the surface of the active material molded body may occur, however, by setting the heat treatment temperature to 920° C. or lower, the side reaction generating Co₃O₄ as described above is prevented, and the deterioration of the cycle characteristics in the case where the active material molded body is used in a lithium secondary battery can be prevented.

Another aspect of the invention provides an active material molded body including a sintered body powdery of LiₓCoO₂ (wherein 0<x<1) in the form of a powder and having an activation energy of 0.2 eV or less.

According to this configuration, the conductivity of the active material molded body can be easily increased, and when a lithium battery is formed using the active material molded body, a sufficient output power can be obtained.

Still another aspect of the invention provides a method for producing a lithium battery including: forming a solid electrolyte layer on an active material molded body selected from the group consisting of active material molded bodies produced by the method for producing an active material molded body according to the aspect of the invention and the active material molded body according to the aspect of the invention by applying a liquid containing a constituent material of an inorganic solid electrolyte to the surface of the active material molded body including the inner surface of each pore of the active material molded body, and then performing a heat treatment; and bonding a current collector to the active material molded body exposed from the solid electrolyte layer.

According to this method, the active material molded body which can achieve favorable electron transfer is used, and a contact area between the active material molded body and the solid electrolyte layer can be easily made larger than a contact area between the current collector and the active material molded body so that the internal electron transfer can be made favorable, and therefore, a high-power lithium battery can be easily produced.

In one aspect of the invention, the production method may be configured such that the active material molded body is one which has been stored in an atmosphere having a water vapor pressure of 15 hPa or less for a period of 7 weeks or less after production.

According to this method, a lithium battery can be produced using the active material molded body in which an increase in the activation energy is prevented, and therefore, a high-power lithium battery can be stably produced.

Yet aspect of the invention provides a lithium battery including an active material molded body selected from the group consisting of active material molded bodies produced by the method for producing an active material molded body according to the aspect of the invention and the active material molded body according to the aspect of the invention in a positive electrode or a negative electrode.

According to this configuration, an electrode has the above-mentioned active material molded body, and therefore, a high-power and high-capacity lithium battery can be formed.

### BRIEF DESCRIPTION OF THE DRAWINGS

The invention will be described with reference to the accompanying drawings, wherein like numbers reference like elements.

FIGS. 1A and 1B are process diagrams showing a method for producing an electrode assembly according to an embodiment.

FIGS. 2A and 2B are process diagrams showing a method for producing an electrode assembly according to an embodiment.

FIGS. 3A and 3B are process diagrams showing a method for producing an electrode assembly according to an embodiment.

FIG. 4 is a process diagram showing a method for producing an electrode assembly according to an embodiment.

FIG. 5 is a cross-sectional side view showing a modification example of an electrode assembly produced by a production method according to an embodiment.

FIG. 6 is a cross-sectional side view showing a modification example of an electrode assembly produced by a production method according to an embodiment.

FIGS. 7A and 7B are process diagrams showing a modification example of a method for producing an electrode assembly according to an embodiment.

### DESCRIPTION OF EXEMPLARY EMBODIMENTS

### Method for Producing Electrode Assembly

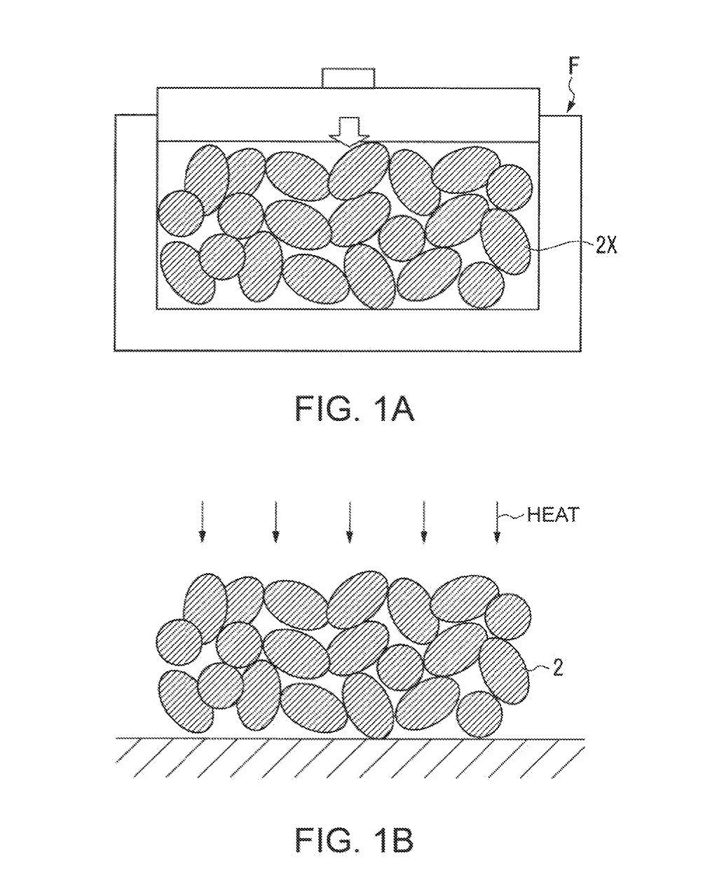

First, with reference to FIGS. 1A and 1B, a method for producing an active material molded body 2 according to this embodiment will be described. FIGS. 1A and 1B are process diagrams showing the method for producing an active material molded body 2 according to this embodiment.

In the method for producing an active material molded body 2 according to this embodiment, as shown in FIGS. 1A and 1B, a constituent material containing LiCoO₂ in the form of particles (hereinafter referred to as “active material particles 2X”) is molded by compression using a mold F (FIG. 1A), followed by a heat treatment, whereby an active material molded body 2 is obtained (FIG. 1B).

In this specification, a solid solution obtained by substituting some atoms in a crystal of LiCoO₂ with a transition metal, a typical metal, an alkali metal, an alkaline rare earth element, a lanthanoid, a chalcogenide, a halogen, or the like can also be used as the constituent material of the active material particles 2X.

By performing the heat treatment, grain boundary growth in the active material particles 2X and sintering between the active material particles 2X are allowed to proceed so that the retention of the shape of the obtained active material molded body 2 is facilitated, and thus, the addition amount of a binder in the active material molded body 2 can be decreased. Further, a bond is formed between the active material particles 2X by sintering so as to form an electron transfer pathway between the active material particles 2X, and therefore, the addition amount of a conducting aid can also be decreased. As the constituent material of the active material particles 2X, LiCoO: can be preferably used.

The obtained active material molded body 2 is configured such that a plurality of pores of the active material molded body 2 communicate like a mesh with one another inside the active material molded body 2.

The average particle diameter of the active material particles 2X is preferably 300 nm or more and 5 μm or less. When an active material having such an average particle diameter is used, the porosity of the obtained active material molded body 2 falls within the range of 10% to 50%. As a result, a surface area of the inner surface of each pore of the active material molded body 2 is easily increased. Further, when the active material molded body 2 has such a porosity, as will be described in detail below, a contact area between the active material molded body 2 and a solid electrolyte layer is easily increased, and thus, the capacity of a lithium battery using the active material molded body 2 is easily increased.

The average particle diameter of the active material particles 2X can be determined by dispersing the active material particles 2X in n-octanol at a concentration ranging from 0.1 to 10% by mass, and then, measuring the median diameter using a light scattering particle size distribution analyzer (Nanotrac UPA-EX250, manufactured by Nikkiso Co., Ltd.).

If the average particle diameter of the active material particles 2X is less than 300 nm, the pores of the formed active material molded body tend to be small such that the radius of each pore is several tens of nanometers, and it becomes difficult to allow a liquid containing a precursor of the inorganic solid electrolyte to penetrate into each pore in the below-mentioned step. As a result, it becomes difficult to form the solid electrolyte layer which is in contact with the surface of the inside of each pore.

If the average particle diameter of the active material particles 2X exceeds 5 μm, a specific surface area which is a surface area per unit mass of the formed active material molded body is decreased, and thus, a contact area between the active material molded body 2 and the solid electrolyte layer is decreased. Therefore, when forming a lithium battery using the obtained active material molded body 2, a sufficient output power cannot be obtained. Further, the ion diffusion distance from the inner part of the active material molded body 2 (the active material particle 2X) to the solid electrolyte layer which is formed in contact with the surface of the active material molded body 2 is increased, and therefore, it becomes difficult for LiCoO₂ around the center of the active material particle 2X to contribute to the function of a battery.

The average particle diameter of the active material particles 2X is more preferably 450 nm or more and 3 μm or less, further more preferably 500 nm or more and 1 μm or less.

In the constituent material to be used for forming the active material molded body 2, an organic polymer compound such as polyvinylidene fluoride (PVdF), polyvinyl alcohol (PVA), or polytetrafluoroethylene (PTFE) may be added as a binder to the active material particles 2X. Such a binder is burned or oxidized in the heat treatment in this step, and the amount thereof is reduced or eliminated.

Further, to the constituent material to be used, a filler (a conducting aid) having conductive properties such as acetylene black or ketchen black (registered trademark) or an inorganic compound (a flux or a sintering aid), which accelerates the melting of LiCoO₂ to facilitate firing, such as lithium carbonate, boric acid, or aluminum oxide (alumina) may be added within a range which does not impair the effect of the invention.

Further, to the constituent material to be used, as a pore template when press-molding the powder, a pore-forming material in the form of particles composed of a polymer or a carbon powder may be added. By mixing such a pore-forming material therein, the porosity of the active material molded body can be controlled. Such a pore-forming material is decomposed and removed by burning or oxidation during the heat treatment, and the amount of the pore-forming material is reduced in the obtained active material molded body.

The average particle diameter of the pore-forming material is preferably from 0.5 to 10 μm.

The heat treatment in this step is performed at a temperature of 900° C. or higher and lower than the melting point of LiCoO₂. By this heat treatment, the active material particles 2X are sintered with one another, whereby an integrated active material molded body 2 can be formed.

By performing the heat treatment at a temperature in such a range, the activation energy of the obtained active material molded body 2 can be decreased without adding a conducting aid, and thus, the resistivity of the active material molded body 2 can be decreased (the conductivity of the active material molded body 2 can be increased). Accordingly, when forming a lithium battery using the active material molded body 2, a sufficient output power can be obtained.

If the treatment temperature is lower than 900° C., sintering does not sufficiently proceed so that the active material particles 2X do not sufficiently contact with one another, and therefore, when forming a lithium battery using the obtained active material molded body 2, a desired output power cannot be obtained.

By setting the heat treatment temperature to 900° C. or higher, the activation energy of the active material molded body 2 can be decreased to 2×10⁻¹ eV or less, and the electronic properties of the active material molded body 2 become like those of a metal. When using such an active material molded body 2, the electrical resistance of an electrode in a lithium battery is decreased so that the internal resistance of the lithium battery is decreased, and thus, the output power of the battery is improved.

By limiting the heat treatment temperature to a value lower than the melting point of LiCoO₂, the melting or decomposition of LiCoO₂ can be prevented, and therefore an active material molded body 2 having desired shape and physical properties can be obtained.

Further, the treatment temperature in the heat treatment in this step is more preferably 900° C. or higher and 920° C. or lower. If the heat treatment is performed at a temperature higher than 920° C. although the treatment temperature is lower than the melting point of LiCoO₂, a side reaction generating Co₃O₄ from LiCoO₂ on the surface of the active material molded body 2 may occur. If Co₃O₄ is generated on the surface on which a battery reaction occurs in the active material molded body 2, for example, in a lithium secondary battery using the active material molded body 2, the charge/discharge cycle may not be preferably performed.

That is, if the heat treatment is performed at a temperature higher than 920° C., a decrease in the activation energy and a deterioration of the cycle properties due to the generation of Co₃O₄ occur as competitive reactions, and therefore, it becomes difficult to stably produce an active material molded body 2 having desired physical properties.

However, in the case where the heat treatment temperature is set to 920° C. or lower, the side reaction generating Co₃O₄ as described above does not occur, and therefore, when the active material molded body 2 is used in a lithium secondary battery, the deterioration of the cycle properties can be prevented. It is a matter of course that in the case where the active material molded body 2 is not used in a secondary battery, it does not matter if the heat treatment is performed at a temperature higher than 920° C. to generate Co₃O₄ as a side product on the surface of the active material molded body 2.

Further, the heat treatment in this step is performed for preferably 5 minutes or more and 36 hours or less, more preferably 4 hours or more and 14 hours or less.

Further, the heat treatment in this step is preferably performed in an oxygen-containing atmosphere having an oxygen partial pressure of 0.1 Pa or more and 101 kPa or less. When the heat treatment is performed in such an atmosphere, the reduction of LiCoO₂ during the heat treatment can be prevented, and therefore an active material molded body 2 having desired physical properties is easily produced. When the heat treatment is performed in an air atmosphere as the oxygen-containing atmosphere, special control of the concentration of oxygen is not needed, and therefore, the step becomes simple.

By such a method for producing the active material molded body 2 according to this embodiment, the active material molded body 2 can be favorably produced.

The active material molded body 2 according to this embodiment includes a sintered body of powdery LiₓCoO₂ (wherein 0<x<1) having an activation energy of 0.2 eV or less. The active material molded body 2 is a porous molded body, and a plurality of pores of the active material molded body 2 communicate like a mesh with one another inside the active material molded body 2.

The active material molded body 2 preferably has a porosity of 10% or more and 50% or less. As will be described in detail below, when the active material molded body 2 has such a porosity, a surface area of the inner surface of each pore of the active material molded body 2 is increased, and also a contact area between the active material molded body 2 and the solid electrolyte layer formed on the surface of the active material molded body 2 is easily increased. Accordingly, the capacity of a lithium battery using the active material molded body 2 is easily increased.

The porosity can be determined according to the following formula (I) from (1) the volume (apparent volume) of the active material molded body 2 including the pores obtained from the external dimension of the active material molded body 2, (2) the mass of the active material molded body 2, and (3) the density of the active material constituting the active material molded body 2.

Porosity (%)=[1−(mass of active material molded body)/(apparent volume)×(density of active material)]×100 (I)

Since the activation energy of the active material molded body 2 is 0.2 eV or less, the conductivity of the active material molded body 2 is easily increased, and therefore, when forming a lithium battery using the active material molded body 2, a sufficient output power can be obtained.

The activation energy of the active material molded body 2 can be determined by the following method.

In the determination of the activation energy, first, the active material molded body 2 is molded into a disk having a diameter of 10 mm and a thickness of 0.3 mm. Then, a Pt electrode is formed by sputtering on each of the top and bottom surfaces facing each other of the disk-shaped active material molded body 2.

Subsequently, while changing the temperature from room temperature (25° C.) to 150° C. in a thermoregulated bath, a flowing current is measured with respect to the applied voltage at each measurement temperature using a source meter (model 2400, manufactured by Keithley Instruments, Inc.). By using the measurement results, a current-voltage characteristic curve (hereinafter referred to as “I-V curve”) showing a relationship between the current and the applied voltage is created, and based on the slope of the I-V curve, the conductivity of the active material molded body at each measurement temperature is determined.

Subsequently, a relationship of the determined conductivity against the inverse of temperature for each measurement temperature (Arrhenius plot) is created, and the activation energy Eₐ of the active material molded body can be determined according to the following formula (1).

K=exp[−Eₐ/kT] (1)

In the formula (I), K represents a conductivity (S/cm), Eₐ represents an activation energy (eV), k represents the Boltzmann constant (8.6173×10⁻⁵ (eV/K), and T represents a measurement temperature (K).

The active material molded body 2 according to this embodiment has the configuration as described above.

The obtained active material molded body 2 can be stored in an atmosphere having a water vapor pressure of 15 hPa or less for a period of 7 weeks or less after production. The atmosphere having a water vapor pressure of 15 hPa or less is an atmosphere in which the dew point at atmospheric pressure is 13° C. or lower. By storing the active material molded body 2 in such an atmosphere, an increase in the activation energy of the active material molded body can be suppressed, and a high-power lithium battery can be stably produced.

If the obtained active material molded body 2 is left in the air, water vapor in the air and LiCoO₂ react with each other so that the activation energy is increased. However, by storing the active material molded body 2 in the above-mentioned atmosphere, an increase in the activation energy can be suppressed. Even if the activation energy of the active material molded body 2 is increased by the reaction between environmental water vapor and LiCoO₂, by performing a heat treatment of the active material molded body 2 whose activation energy has been increased at a temperature of 900° C. or higher and not higher than the melting point of LiCoO₂ again, the activation energy can be decreased again to a preferred value of 0.2 eV or less.

The water vapor pressure in the atmosphere in which the active material molded body 2 is stored is more preferably 0.02 hPa (dew point: −60° C.) or less. Further, the storage period is more preferably 1 day or less. By decreasing the water vapor pressure in the atmosphere in which the active material molded body 2 is stored or by shortening the storage period, an increase in the activation energy of LiCoO₂ can be effectively suppressed.

The atmosphere in which the active material molded body 2 is stored is preferably an inert gas atmosphere such as N₂, Ar, or CO₂, or an oxidizing atmosphere such as dry air because the handling is easy.

Further, the atmosphere in which the active material molded body 2 is stored may be a reduced-pressure atmosphere having a pressure of 15 hPa or less.

In the same atmosphere as such a storage atmosphere, a composite body, an electrode assembly, or a lithium battery may be produced using the active material molded body 2 by the below-mentioned method for producing a lithium battery. By doing this, an increase in the activation energy of the active material molded body 2 during the production can be effectively suppressed, and a high-quality product can be produced.

### Method for Producing Lithium Battery

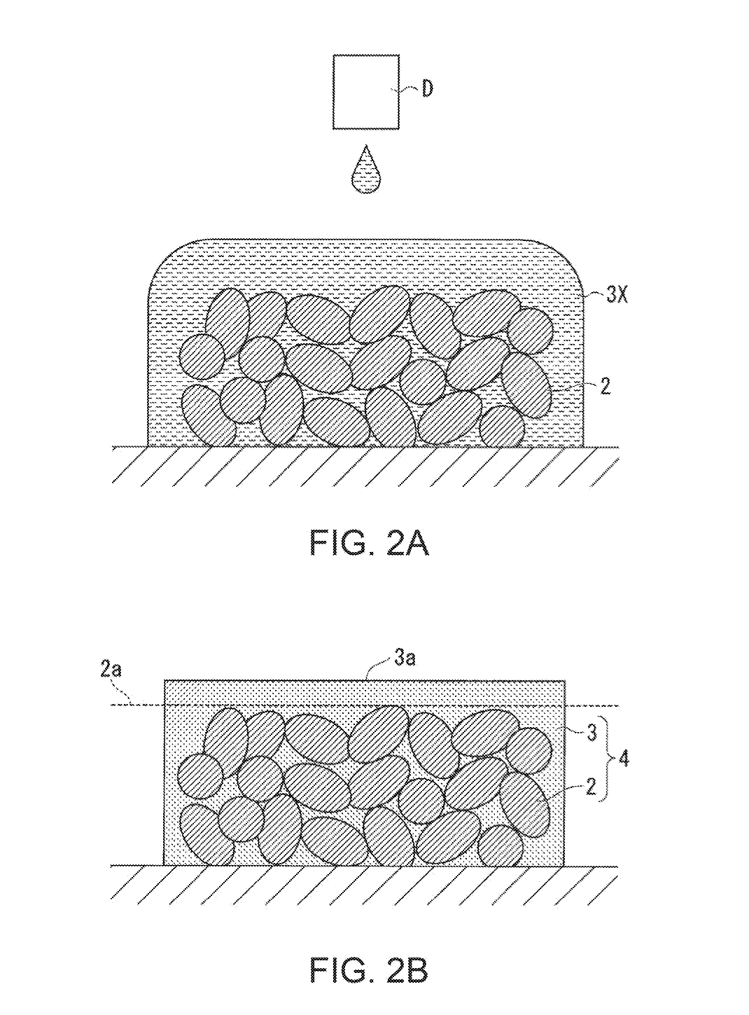

Next, with reference to FIGS. 2A to 4B, a method for producing a lithium battery according to this embodiment will be described. FIGS. 2A to 4B are explanatory diagrams showing the method for producing a lithium battery.

First, as shown in FIGS. 2A and 2B, a liquid 3X containing a precursor of an inorganic solid electrolyte is applied to the surface of an active material molded body 2 including the inside of each pore of the active material molded body 2 (FIG. 2A), followed by firing to convert the precursor to the inorganic solid electrolyte, whereby a solid electrolyte layer 3 is formed (FIG. 2B). A structure in which the active material molded body 2 and the solid electrolyte layer 3 are combined is referred to as “composite body 4”.

As described above, as the active material molded body 2, one stored in an atmosphere having a water vapor pressure of 15 hPa or less for a period of 7 weeks or less after production is used. By doing this, an increase in the activation energy of the active material molded body can be suppressed, and a high-power lithium battery can be stably produced.

The obtained solid electrolyte layer 3 is composed of a solid electrolyte, and is provided in contact with the surface of the active material molded body 2 including the inner surface of each pore of the active material molded body 2.

Examples of the solid electrolyte include oxides, sulfides, halides, and nitrides such as SiO₂—P₂O₅—Li₂O, SiO₂—P₂O₅—LiCl, Li₂O—LiCl—B₂O₃, Li_{3.4}V_{0.6}Si_{0.4}O₄, Li₁₄ZnGe₄O₁₆, Li_{3.6}V_{0.4}Ge_{0.5}O₄, Li_{1.3}Ti_{1.7}Al_{0.3}(PO₄)₃, Li_{2.88}PO_{3.73}N_{0.14}, LiNbO₃, Li_{0.35}La_{0.55}TiO₃, Li₇La₃Zr₂O₁₂, Li₂S—SiS₂, Li₂S—SiS₂—LiI, Li₂S—SiS₂—P₂S₅, LiPON, Li₃N, LiI, LiI—CaI₂, LiI—CaO, LiAlCl₄, LiAlF₄, LiI—Al₂O₃, LiF—Al₂O₃, LiBr—Al₂O₃, Li₂O—TiO₂, La₂O₃—Li₂O—TiO₂, Li₃N, Li₃Ni₂, Li₃N—Li-LiOH, Li₃N—LiCl, Li₆NBr₃, LiSO₄, Li₄SiO₄, Li₄PO₄—Li₄SiO₄, Li₄GeO₄—Li₃VO₄, Li₄SiO₄—Li₃VO₄, Li₄GeO₄—Zn₂GeO₂, Li₄SiO₄—LiMoO₆, Li₃PO—Li₄SiO₄, and LiSiO₄—Li₄ZrO₄. These solid electrolytes may be crystalline or amorphous. Further, in this specification, a solid solution obtained by substituting some atoms of any of these compositions with a transition metal, a typical metal, an alkali metal, an alkaline rare earth element, a lanthanoid, a chalcogenide, a halogen, or the like can also be used as the solid electrolyte.

The ionic conductivity of the solid electrolyte layer 3 is preferably 1×10⁻⁵ S/cm or more. When the solid electrolyte layer 3 has such an ionic conductivity, ions contained in the solid electrolyte layer 3 at a position away from the surface of the active material molded body 2 reach the surface of the active material molded body 2 and can also contribute to a battery reaction in the active material molded body 2. Accordingly, the utilization of the active material in the active material molded body 2 is improved, and thus the capacity can be increased. At this time, if the ionic conductivity is less than 1×10⁻⁵ S/cm, when the electrode assembly is used in a lithium battery, only the active material in the vicinity of the top layer of the surface facing a counter electrode contributes to the battery reaction in the active material molded body 2, and therefore, the capacity may be decreased.

The term “ionic conductivity of the solid electrolyte layer 3” as used herein refers to the “total ionic conductivity”, which is the sum of the “bulk conductivity”, which is the conductivity of the above-mentioned inorganic electrolyte itself constituting the solid electrolyte layer 3, and the “grain boundary ionic conductivity”, which is the conductivity between crystal grains when the inorganic electrolyte is crystalline.

The ionic conductivity of the solid electrolyte layer 3 can be determined as follows. A tablet-shaped body obtained by press-molding a solid electrolyte powder at 624 MPa is sintered at 700° C. in an air atmosphere for 8 hours, a platinum electrode is formed by sputtering, and then, performing an AC impedance method.

The liquid 3X shown in FIG. 2A may contain a solvent which can dissolve the precursor in addition to the precursor. In the case where the liquid 3X contains a solvent, after applying the liquid 3X, the solvent may be appropriately removed before firing. As the method for removing the solvent, a generally known method such as heating, pressure reduction, or air-blowing, or a method in which two or more such generally known methods are combined can be adopted.

Since the solid electrolyte layer 3 is formed by applying the liquid 3X having fluidity, it becomes possible to favorably form a solid electrolyte also on the inner surface of each fine pore of the active material molded body 2. Accordingly, a contact area between the active material molded body 2 and the solid electrolyte layer 3 is easily increased so that a current density at an interface between the active material molded body 2 and the solid electrolyte layer 3 is decreased, and thus, it becomes easy to obtain a high output power.

The liquid 3X can be applied by any of various methods as long as the method can allow the liquid 3X to penetrate into the pores of the active material molded body 2. For example, a method in which the liquid 3X is added dropwise to a place where the active material molded body 2 is placed, a method in which the active material molded body 2 is immersed in a place where the liquid 3X is pooled, or a method in which an edge portion of the active material molded body 2 is brought into contact with a place where the liquid 3X is pooled so that the inside of each pore is impregnated with the liquid 3X by utilizing a capillary phenomenon may be adopted. In FIG. 2A, a method in which the liquid 3X is added dropwise using a dispenser D is shown.

Examples of the precursor include the following precursors (A) and (B): (A) a composition including salts which contains a metal atoms to be contained in the inorganic solid electrolyte at a ratio according to the compositional formula of the inorganic solid electrolyte, and is converted to the inorganic solid electrolyte by oxidation; and (B) a composition including metal alkoxides containing metal atoms to be contained in the inorganic solid electrolyte at a ratio according to the compositional formula of the inorganic solid electrolyte.

The salt to be contained in the precursor (A) includes a metal complex. Further, the precursor (B) is a precursor when the inorganic solid electrolyte is formed using a so-called sol-gel method.

The precursor is fired in an air atmosphere at a temperature lower than the temperature in the heat treatment for obtaining the active material molded body 2 described above. The firing may be performed at a temperature of 300° C. or higher and 700° C. or lower. By the firing, the inorganic solid electrolyte is produced from the precursor, thereby forming the solid electrolyte layer 3. As the constituent material of the solid electrolyte layer, Li_{0.35}La_{0.55}TiO₃ can be preferably used.

By performing firing at a temperature in such a range, a solid phase reaction occurs at an interface between the active material molded body 2 and the solid electrolyte layer 3 due to mutual diffusion of elements constituting the respective members, and the production of electrochemically inactive side products can be suppressed. Further, the crystallinity of the inorganic solid electrolyte is improved, and thus, the ionic conductivity in the solid electrolyte layer 3 can be improved. In addition, at the interface between the active material molded body 2 and the solid electrolyte layer 3, a sintered portion is generated, and thus, electron transfer at the interface is facilitated.

Accordingly, the capacity and the output power of a lithium battery using the active material molded body 2 are improved.

The firing may be performed by performing a heat treatment once, or may be performed by dividing the heat treatment into a first heat treatment in which the precursor is adhered to the surface of the porous body and a second heat treatment in which heating is performed at a temperature not lower than the treatment temperature in the first heat treatment and 700° C. or lower. By performing the firing by such a stepwise heat treatment, the solid electrolyte layer 3 can be easily formed at a desired position.

In the composite body 4, when the direction away from the surface of the current collector 1 in the normal direction is defined as the upper direction, the surface 3a on the upper side of the solid electrolyte layer 3 is located above the upper edge position 2a of the active material molded body 2. That is, the solid electrolyte layer 3 is formed above the upper edge position 2a of the active material molded body 2. According to this configuration, when producing a lithium battery by providing an electrode on the surface 3a as described below, the electrode provided on the surface 3a and the counter electrode are not connected to each other through the active material molded body 2, and therefore, a short circuit can be prevented.

The composite body 4 is formed without using an organic material such as a binder for binding the active materials to each other or a conducting aid for securing the conductive properties of the active material molded body 2 when forming the active material molded body 2, and is composed of almost only an inorganic material. Specifically, a percentage of weight loss when the composite body 4 is heated to 400° C. for 30 minutes is 5% by mass or less. The weight is preferably 3% by mass or less, more preferably lwt % or less, and particularly preferably the mass loss is not observed or is the limit of error. That is, the mass loss percentage when the composite body 4 is heated to 400° C. for 30 minutes is preferably 0% by mass or more.

Since the composite body 4 shows a mass loss percentage as described above, in the composite body 4, a material which is evaporated under predetermined heating conditions such as a solvent or adsorbed water, or an organic material which is vaporized by burning or oxidation under predetermined heating conditions is contained in an amount of only 5% by mass or less with respect to the total mass of the structure.

The mass loss percentage of the composite body 4 can be determined as follows. By using a thermogravimetric/differential thermal analyzer (TG-DTA), the composite body 4 is heated under predetermined heating conditions, and the mass of the composite body 4 after heating under the predetermined heating conditions is measured, and the mass loss percentage is calculated from the ratio between the mass before heating and the mass after heating.

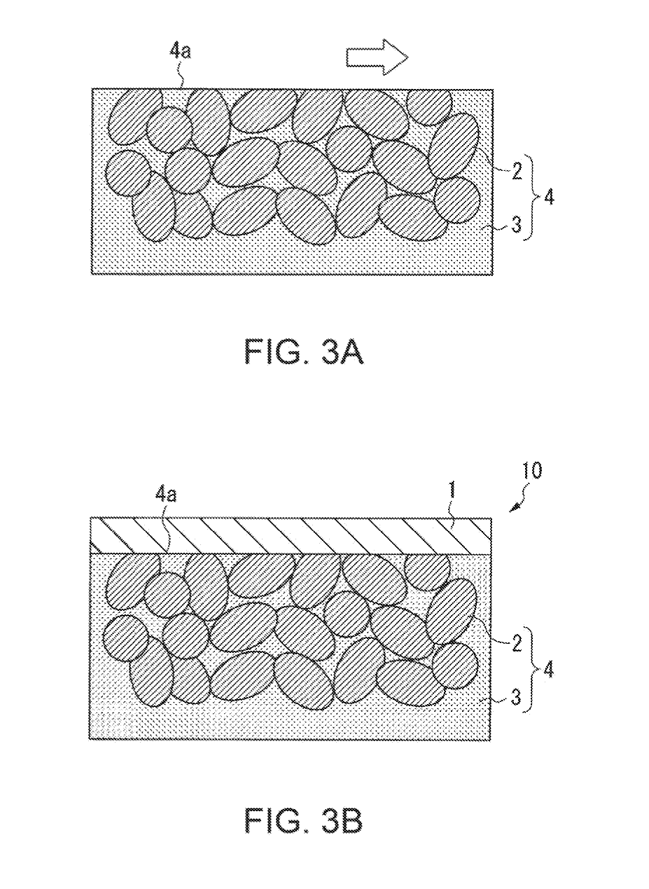

Subsequently, as shown in FIGS. 3A and 3B, the current collector 1 is bonded to the active material molded body 2 exposed on one surface of the composite body 4 including the active material molded body 2 and the solid electrolyte layer 3, whereby an electrode assembly 10 is produced. In this embodiment, the electrode assembly 10 is produced by polishing one surface of the composite body 4 (FIG. 3A), and then, forming the current collector 1 on the surface 4a (polished surface) of the composite body 4 (FIG. 3B).

By polishing the surface 4a of the composite body 4 before bonding the current collector 1 thereto, the active material molded body 2 is reliably exposed on the surface 4a of the composite body 4, and thus, the current collector 1 and the active material molded body 2 can be reliably bonded to each other.

Incidentally, the active material molded body 2 may be sometimes exposed on the surface to be in contact with the mounting surface of the composite body 4 when forming the composite body 4. In this case, even if the composite body 4 is not polished, the current collector 1 and the active material molded body 2 can be bonded to each other.

The current collector 1 is provided in contact with the active material molded body 2 exposed from the solid electrolyte layer 3 on the surface 4a of the composite body 4. As a constituent material of the current collector 1, one species of metal (an elemental metal) selected from the group consisting of copper (Cu), magnesium (Mg), titanium (Ti), iron (Fe), cobalt (Co), nickel (Ni), zinc (Zn), aluminum (Al), germanium (Ge), indium (In), gold (Au), platinum (Pt), silver (Ag), and palladium (Pd), or an alloy containing two or more kinds of metal elements selected from this group can be used.

As the shape of the current collector 1, a plate, a foil, a mesh, etc. can be adopted. The surface of the current collector 1 may be smooth, or may have roughness formed thereon.

The bonding of the current collector 1 may be performed by bonding the current collector formed as a separate body to the surface 4a of the composite body 4, or may be performed by depositing a constituent material of the current collector 1 described above on the surface 4a of the composite body 4, thereby forming the current collector 1 on the surface 4a of the composite body 4. As the deposition method, a generally known physical vapor deposition method (PVD) or chemical vapor deposition method (CVD) can be adopted.

In the electrode assembly 10 of this embodiment, a plurality of pores communicate like a mesh with one another inside the active material molded body 2, and also in the solid portion of the active material molded body 2, a mesh structure is formed. LiCoO₂ which is a constituent material of the active material molded body 2 is known to have anisotropic electron conductivity in crystals. When the active material molded body is tried to be formed using LiCoO₂ as a constituent material, in the case where the active material molded body has a configuration such that pores are formed by a mechanical process so as to extend in a specific direction, electron conduction may possibly hardly take place therein depending on the direction on which crystals show electron conductivity. However, if the pores communicate like a mesh with one another as in the case of the active material molded body 2 and the solid portion of the active material active body 2 has a mesh structure, an electrochemically smooth continuous surface can be formed regardless of the anisotropic electron conductivity or ionic conductivity in crystals. Accordingly, favorable electron conduction can be secured regardless of the type of active material to be used.

Further, in the electrode assembly 10 of this embodiment, since the composite body 4 has a configuration as described above, the addition amount of a binder or a conducting aid contained in the composite body 4 is reduced, and thus, as compared with the case where a binder or a conducting aid is used, the capacity density per unit volume of the electrode assembly 10 is improved.

Further, in the electrode assembly 10 of this embodiment, the solid electrolyte layer 3 is in contact also with the inner surface of the inside of each pore of the porous active material molded body 2. Therefore, as compared with the case where the active material molded body 2 is not porous or the case where the solid electrolyte layer 3 is not formed in the pores, a contact area between the active material molded body 2 and the solid electrolyte layer 3 is increased, and thus, an interfacial impedance can be decreased. Accordingly, favorable charge transfer at an interface between the active material molded body 2 and the solid electrolyte layer 3 can be achieved.

Further, in the electrode assembly 10 of this embodiment, while the current collector 1 is in contact with the active material molded body 2 exposed on one surface of the composite body 4, the solid electrolyte layer 3 penetrates into the pores of the porous active material molded body 2 and is in contact with the surface of the active material molded body 2 including the inside of each pore and excluding the surface in contact with the current collector 1. It is apparent that in the electrode assembly 10 having such a configuration, a contact area between the active material molded body 2 and the solid electrolyte layer 3 (a second contact area) is larger than a contact area between the current collector 1 and the active material molded body 2 (a first contact area).

If the electrode assembly has a configuration such that the first contact area and the second contact area are the same, since charge transfer is easier at an interface between the current collector 1 and the active material molded body 2 than at an interface between the active material molded body 2 and the solid electrolyte layer 3, the interface between the active material molded body 2 and the solid electrolyte layer 3 becomes a bottleneck of the charge transfer. Due to this, favorable charge transfer is inhibited in the electrode composite as a whole.

However, in the electrode assembly 10 of this embodiment, the second contact area is larger than the first contact area, and therefore, the above-mentioned bottleneck is easily eliminated, and thus, favorable charge transfer can be achieved in the electrode assembly as a whole.

Accordingly, the electrode assembly 10 produced by the production method of this embodiment can improve the capacity of a lithium battery using the electrode assembly 10, and also the output power can be increased.

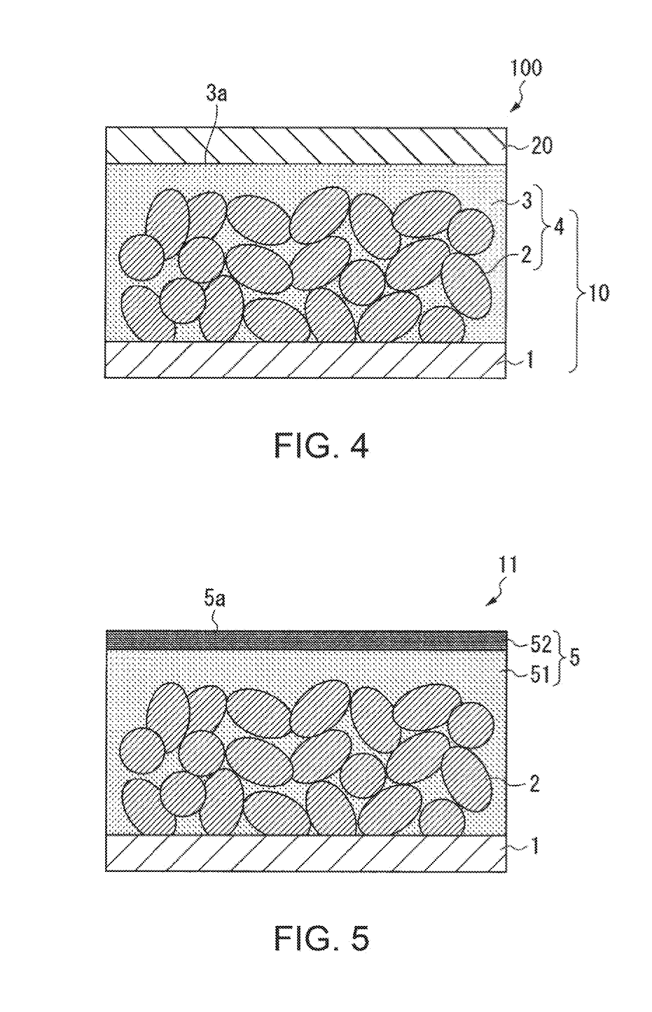

Subsequently, as shown in FIG. 4, to the surface 3a of the obtained electrode assembly 10, a negative electrode 20 is bonded, whereby a lithium battery 100 is formed. That is, in the lithium battery 100, the active material molded body 2 is used as a positive electrode active material.

As a material of the negative electrode 20, for example, lithium metal or indium metal can be used. The negative electrode 20 may be provided in such a manner that an electrode is formed as a separate body and press-bonded to the electrode assembly 10, or an electrode is directly formed on the surface 3a of the electrode assembly 10 using lithium metal or indium metal by, for example, a generally known physical vapor deposition method such as sputtering or vapor deposition.

In this manner, the lithium battery 100 can be produced.

According to the method for producing the lithium battery 100 as described above, since the active material molded body 2 produced by the above-mentioned production method is used, a high-power and high-capacity lithium battery can be easily produced.

Further, according to the lithium battery 100 as described above, since the active material molded body 2 produced by the above-mentioned production method is used, the output power and the capacity can be increased.

### Modification Example 1

In this embodiment, the solid electrolyte layer 3 is composed of a single layer, however, it does not matter if a solid electrolyte layer is composed of a plurality of layers.

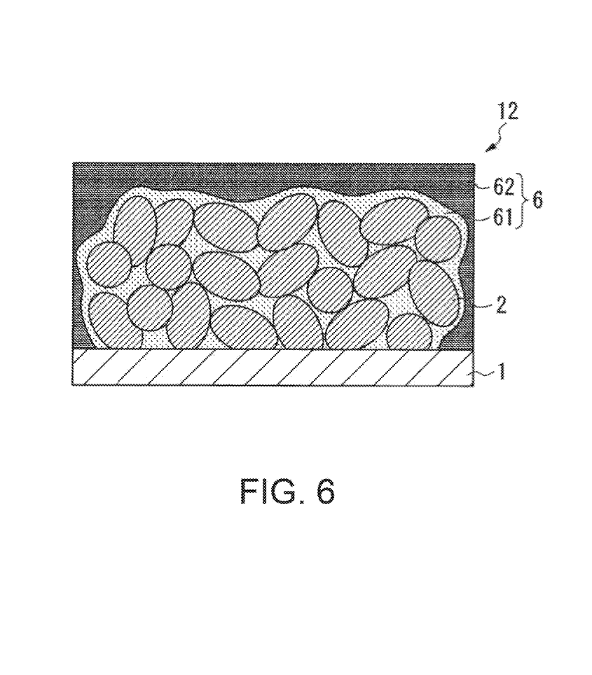

FIGS. 5 and 6 are cross-sectional side views of a main part showing a modification example of an electrode assembly.

An electrode assembly 11 shown in FIG. 5 includes a current collector 1, an active material molded body 2, a first electrolyte layer 51 which is composed of a solid electrolyte and is provided in contact with the surface of the active material molded body 2 including the inner surface of each pore of the active material molded body 2, and a second electrolyte layer 52 which is provided thinly in contact with the surface of the first electrolyte layer 51. The first electrolyte layer 51 and the second electrolyte layer 52 constitute a solid electrolyte layer 5 as a whole. The solid electrolyte layer 5 is configured such that the volume of the first electrolyte layer 51 is larger than that of the second electrolyte layer 52.

The solid electrolyte layer 5 in which a plurality of layers are laminated can be produced by performing the method for producing the solid electrolyte layer 3 described above for each of the plurality of layers. Alternatively, after a liquid for forming the first electrolyte layer 51 is applied, a precursor is adhered by performing a first heat treatment, and then, a liquid for forming the second electrolyte layer 52 is applied, and thereafter, a precursor is adhered by performing the first heat treatment, and then, the adhered precursors in the plurality of layers are subjected to a second heat treatment, whereby the solid electrolyte layer 5 in which a plurality of layers are laminated may be formed.

As the constituent materials of the first electrolyte layer 51 and the second electrolyte layer 52, the same constituent materials as those of the solid electrolyte layer 3 described above can be adopted. The constituent materials of the first electrolyte layer 51 and the second electrolyte layer 52 may be the same as or different from each other. By providing the second electrolyte layer 52, when a lithium battery having the electrode assembly 11 is produced by providing an electrode on the surface 5a of the solid electrolyte layer 5, a short circuit caused by connecting the electrode provided on the surface 5a to the current collector 1 through the active material molded body 2 can be prevented.

Further, when a lithium battery including the electrode assembly 11 is produced, if an alkali metal is selected as the material of an electrode to be formed, depending on an inorganic solid electrolyte constituting the solid electrolyte layer, due to the reducing activity of the alkali metal, the inorganic solid electrolyte constituting the solid electrolyte layer is reduced so that the function of the solid electrolyte layer may be lost. In such a case, when an inorganic solid electrolyte which is stable for the alkali metal is selected as the constituent material of the second electrolyte layer 52, the second electrolyte layer 52 functions as a protective layer for the first electrolyte layer 51, and thus, the degree of freedom of choosing the material of the first electrolyte layer 51 is increased.

In the case where the second electrolyte layer is used as a protective layer for the first electrolyte layer as in the case of the electrode assembly 11, if the electrode assembly has a configuration such that the second electrolyte layer is interposed between the first electrolyte layer and the electrode provided on the surface of the solid electrolyte layer, the volume ratio between the first electrolyte layer and the second electrolyte layer can be appropriately changed.

For example, as an electrode assembly 12 shown in FIG. 6, the electrode assembly may have a configuration such that a solid electrolyte layer 6 includes a first electrolyte layer 61, which is formed thinly in contact with the surface of the active material molded body 2 including the inner surface of each pore of the active material molded body 2, and also includes a second electrolyte layer 62 which is formed thickly and is provided in contact with the surface of the first electrolyte layer 61, and the volume of the second electrolyte layer 62 is made larger than that of the first electrolyte layer 61.

### Modification Example 2

In this embodiment, after forming the composite body 4 in which the active material molded body 2 and the solid electrolyte layer 3 are combined, the current collector 1 is formed on the formed composite body 4, however, the invention is not limited thereto.

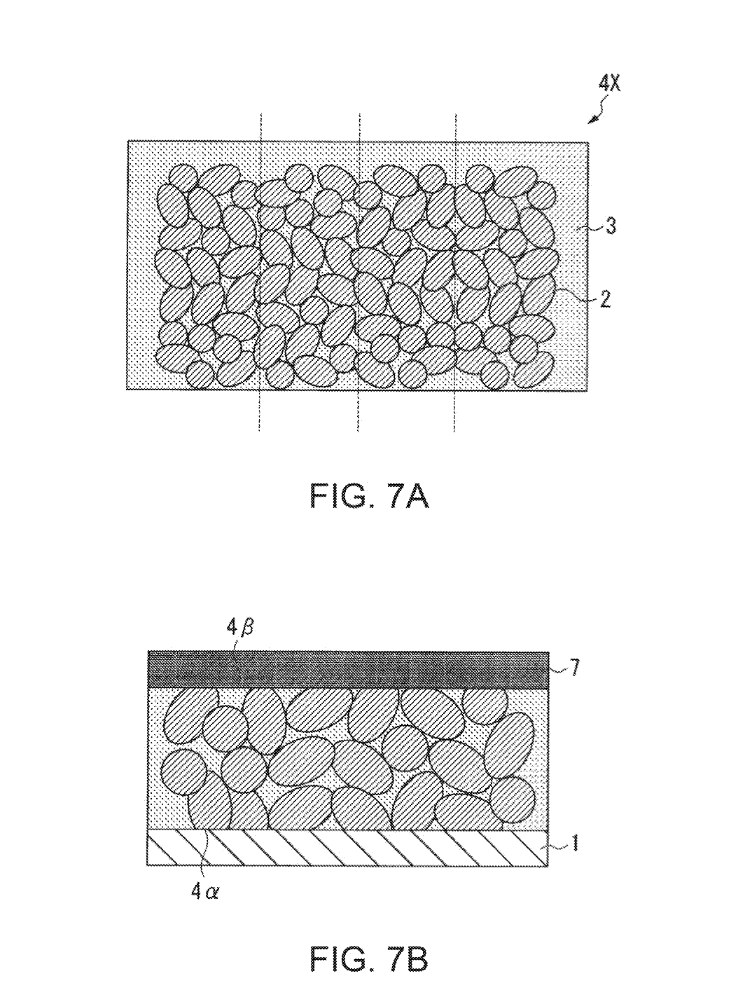

FIGS. 7A and 7B are process diagrams showing a part of a modification example of a method for producing an electrode assembly.

In the method for producing an electrode assembly shown in FIGS. 7A and 7B, first, as shown in FIG. 7A, a bulk body 4X of a structure body in which an active material molded body 2 and a solid electrolyte layer 3 are combined is formed, and then, the bulk body 4X is divided into a plurality of segments in accordance with the size of the objective electrode assembly. In FIG. 7A, a division position is indicated by a broken line, and the drawing shows that the bulk body 4X is divided by cleaving in the direction intersecting the longitudinal direction of the bulk body 4X at a plurality of positions in the longitudinal direction of the bulk body 4X so that the plurality of divided surfaces faces each other.

Subsequently, as shown in FIG. 7B, in a composite body 4Y obtained by cleaving the bulk body 4X, a current collector 1 is formed on one divided surface 4α thereof. Further, on the other divided surface 4β, an inorganic solid electrolyte layer (a solid electrolyte layer 7) covering the active material molded body 2 exposed on the divided surface 4β is formed. The current collector 1 and the solid electrolyte layer 7 can be formed by the above-mentioned method.

According to the method for producing an electrode assembly as described above, by forming the bulk body 4X in advance, the mass production of the electrode assembly capable of forming a high-power lithium battery is facilitated.

In this embodiment, the active material molded body 2 is used as a positive electrode active material, but can be used also as a negative electrode active material.

Hereinabove, preferred embodiments according to the invention are described with reference to the accompanying drawings, however, it is needless to say that the invention is not limited to the embodiments. The shapes of the respective constituent members, combinations thereof, etc. described in the above-mentioned embodiments are merely examples and various modifications can be made based on design requirements, etc. without departing from the gist of the invention.

### EXAMPLES

Hereinafter, the invention will be described with reference to Examples, however, the invention is not limited to these Examples.

### Measurement Method

### Measurement Method for Activation Energy

In a disk-shaped active material molded body produced in each of Examples and Comparative Example, a Pt electrode was formed by sputtering on each of the top and bottom surfaces facing each other.

Subsequently, while changing the temperature from room temperature (25° C.) to 150° C. in a thermoregulated bath, a flowing current was measured with respect to the applied voltage at each measurement temperature using a source meter (model 2400, manufactured by Keithley Instruments, Inc.). By using the measurement results, a current-voltage characteristic curve (hereinafter referred to as “I-V curve”) showing a relationship between the current and the applied voltage was created, and based on the slope of the I-V curve, the conductivity of the active material molded body at each measurement temperature was determined.

Subsequently, a relationship of the determined conductivity against inverse temperature for each measurement temperature (Arrhenius plot) was created, and the activation energy Eₐ of the active material molded body was determined according to the following formula (I).

K=exp[−Eₐ/kT] (1)

In the formula (I), K represents a conductivity (S/cm), Eₐ represents an activation energy (eV), k represents the Boltzmann constant (8.6173×10⁻⁵ (eV/K), and T represents a measurement temperature (K).

### Example 1

100 Parts by mass of LiCoO₂ (manufactured by Sigma-Aldrich Co., Ltd., hereinafter referred to as “LCO”) in the form of a powder and 3 parts by mass of polyacrylic acid (manufactured by Sigma-Aldrich Co., Ltd.) in the form of a powder were mixed with each other, whereby a mixed powder of LCO and polyacrylic acid was obtained.

The Li/Co atomic ratio in the mixed powder as determined by the ICP analysis was 1.01±0.05.

80 mg of the obtained mixed powder was weighed and placed in a pellet die, and then molded into a disk-shaped pellet having a diameter of 10 mm and a thickness of 0.3 mm by applying a pressure of 624 MPa thereto.

The thus obtained pellet was fired at 1000° C. in an air atmosphere for 8 hours in a muffle furnace, whereby an active material molded body 1 was obtained.

The Li/Co atomic ratio in the active material molded body 1 as determined by the ICP analysis was 0.97±0.05.

The activation energy of the active material molded body 1 was 0.11 eV, and the conductivity thereof at room temperature was 4.3×10⁻⁴ S/cm.

### Example 2

In the same manner as in Example 1, an active material molded body 2 was obtained.

The activation energy of the active material molded body 2 was 0.11 eV, and the conductivity thereof at room temperature was 0.35×10⁻⁴ S/cm.

### Example 3

In the same manner as in Example 1 except that the firing temperature was set to 900° C., an active material molded body 3 was obtained.

The Li/Co atomic ratio in the active material molded body 3 as determined by the ICP analysis was 1.02±0.05.

The activation energy of the active material molded body 3 was 0.15 eV, and the conductivity thereof at room temperature was 1.4×10⁻⁴ S/cm.

### Example 4

The active material molded body 1 was exposed to an air atmosphere having a water vapor pressure of 15 hPa at 25° C. for 7 weeks, whereby an active material molded body 4 was obtained.

The activation energy of the active material molded body 4 was 0.21 eV, and the conductivity thereof at room temperature was 0.023×10⁻⁴ S/cm.

### Comparative Example 1

In the same manner as in Example 1 except that the firing temperature was set to 800° C., an active material molded body 5 was obtained.

The Li/Co atomic ratio in the active material molded body 5 as determined by the ICP analysis was 1.01±0.05.

The activation energy of the active material molded body 5 was 0.30 eV, and the conductivity thereof at room temperature was 0.14×10⁻⁴ S/cm.

The results of Examples 1 to 4 and Comparative Example 1 are shown in Table 1.

TABLE 1

| | | | Conductivity at |
|---|---|---|---|
| | Treatment | Activation energy | room temperature |
| | conditions | (eV) | (×10⁻⁴, S/cm) |
| Example 1 | Firing at 1000° C. | 0.11 | 4.3 |
| Example 2 | | 0.11 | 0.35 |
| Example 3 | Firing at 900° C. | 0.15 | 1.4 |
| Example 4 | Firing at 1000° C., | 0.21 | 0.023 |
| | and then, exposing | | |
| | to water vapor | | |
| Comparative | Firing at 800° C. | 0.30 | 0.14 |
| Example 1 | | | |

Based on the results of the evaluation of Examples 1 and 2, it was found that the activation energy does not vary although the measurement values of the conductivity vary by about one digit depending on the production lots. Therefore, it was found that the activation energy is more suitable as an index for evaluating conductive properties than the conductivity.

It was also found that as compared with the active material molded body of Comparative Example 1, the active material molded bodies of Examples 1 to 4 have a low activation energy, and therefore can achieve favorable electron transfer.

Based on these results, the usefulness of the invention was confirmed.

The entire disclosure of Japanese Patent Application No. 2013-020422, filed Feb. 5, 2013 is expressly incorporated reference herein.

What is claimed is:

1. A method for producing an active material molded body, comprising molding a constituent material containing LiCoO₂ in the form of a powder by compression, and then performing a heat treatment at a temperature of 900° C. or higher and lower than the melting point of LiCoO₂.

2. The method for producing an active material molded body according to claim 1, wherein the heat treatment is performed in an oxygen-containing atmosphere having an oxygen partial pressure of 0.1 Pa or more and 101 kPa or less.

3. The method for producing an active material molded body according to claim 2, wherein the heat treatment is performed in an air atmosphere.

4. The method for producing an active material molded body according to claim 1, wherein the heat treatment is performed at a temperature of 900° C. or higher and 920° C. or lower.

5. An active material molded body, comprising a sintered body of LiₓCoO₂ (wherein 0<x<1) in the form of a powder and having an activation energy of 0.2 eV or less.

6. A method for producing a lithium battery, comprising:
forming a solid electrolyte layer on an active material molded body produced by the method for producing an active material molded body according to claim 1 by applying a liquid containing a constituent material of an inorganic solid electrolyte to the surface of the active material molded body including the inner surface of each pore of the active material molded body, and then performing a heat treatment; and
bonding a current collector to the active material molded body exposed from the solid electrolyte layer.

7. A method for producing a lithium battery, comprising:
forming a solid electrolyte layer on an active material molded body produced by the method for producing an active material molded body according to claim 2 by applying a liquid containing a constituent material of an inorganic solid electrolyte to the surface of the active material molded body including the inner surface of each pore of the active material molded body, and then performing a heat treatment; and
bonding a current collector to the active material molded body exposed from the solid electrolyte layer.

8. A method for producing a lithium battery, comprising:
forming a solid electrolyte layer on an active material molded body produced by the method for producing an active material molded body according to claim 3 by applying a liquid containing a constituent material of an inorganic solid electrolyte to the surface of the active material molded body including the inner surface of each pore of the active material molded body, and then performing a heat treatment; and
bonding a current collector to the active material molded body exposed from the solid electrolyte layer.

9. A method for producing a lithium battery, comprising:
forming a solid electrolyte layer on an active material molded body produced by the method for producing an active material molded body according to claim 4 by applying a liquid containing a constituent material of an inorganic solid electrolyte to the surface of the active material molded body including the inner surface of each pore of the active material molded body, and then performing a heat treatment; and
bonding a current collector to the active material molded body exposed from the solid electrolyte layer.

10. A method for producing a lithium battery, comprising:
forming a solid electrolyte layer on the active material molded body according to claim 5 by applying a liquid containing a constituent material of an inorganic solid electrolyte to the surface of the active material molded body including the inside of each pore of the active material molded body, and then performing a heat treatment; and
bonding a current collector to the active material molded body exposed from the solid electrolyte layer.

11. The method for producing a lithium battery according to claim 6, wherein the active material molded body is one which has been stored in an atmosphere having a water vapor pressure of 15 hPa or less for a period of 7 weeks or less after production.

12. The method for producing a lithium battery according to claim 7, wherein the active material molded body is one which has been stored in an atmosphere having a water vapor pressure of 15 hPa or less for a period of 7 weeks or less after production.

13. The method for producing a lithium battery according to claim 8, wherein the active material molded body is one which has been stored in an atmosphere having a water vapor pressure of 15 hPa or less for a period of 7 weeks or less after production.

14. The method for producing a lithium battery according to claim 9, wherein the active material molded body is one which has been stored in an atmosphere having a water vapor pressure of 15 hPa or less for a period of 7 weeks or less after production.

15. The method for producing a lithium battery according to claim 10, wherein the active material molded body is one which has been stored in an atmosphere having a water vapor pressure of 15 hPa or less for a period of 7 weeks or less after production.

16. A lithium battery, comprising an active material molded body produced by the method for producing an active material molded body according to claim 1 in a positive electrode or a negative electrode.

17. A lithium battery, comprising an active material molded body produced by the method for producing an active material molded body according to claim 2 in a positive electrode or a negative electrode.

18. A lithium battery, comprising an active material molded body produced by the method for producing an active material molded body according to claim 3 in a positive electrode or a negative electrode.

19. A lithium battery, comprising an active material molded body produced by the method for producing an active material molded body according to claims 4 in a positive electrode or a negative electrode.

20. A lithium battery, comprising the active material molded body according to claim 5 in a positive electrode or a negative electrode.
